(19) United States
(12) Patent Application Publication
(10) Pub. No.: US 2013/0292533 A1
(43) Pub. Date: Nov. 7, 2013

(54) OBJECT HOLDER

(71) Applicants: Henry Sanderson, CC Breda (NL); Philippe Peyridieu, Milano (IT)

(72) Inventors: Henry Sanderson, CC Breda (NL); Philippe Peyridieu, Milano (IT)

(21) Appl. No.: 13/978,914

(22) PCT Filed: Jan. 3, 2012
(86) PCT No.: PCT/FR12/50014

§ 371 Date: Jul. 10, 2013

(30) Foreign Application Priority Data
Jan. 10, 2011 (FR) 1150197

(51) Int. Cl. B60R 7/08; F16B 2/20

(52) U.S. Cl. CPC B60R 7/082; F16B 2/20
USPC 248/316.7

(57) ABSTRACT

The object holder (1) includes a tongue (11) carrying at one end, by forming a connection area (123), a part (12) which is turned back toward the tongue (11), the object holder (1) being able, in a rest position of the object holder (1), to clamp a support (2) between the tongue (11) and the turned-back part (12), and, in a hooking position, to hold an object (3) by hooking, characterized by the fact that the tongue (11) carries a protrusion which is directed toward the turned-back part (12) and the free end of which is in contact with the support (2) in the rest position of the object holder (1), the connection area (123) being spaced apart from the support (2).

The present invention relates to an object holder which is removably fastened to a support, such as a vehicle sun visor, and which holds one or more objects, for example a pair of glasses, in position.

The applicant realized that the temporary storage of glasses poses a lot of problems because glasses are fragile and small-sized objects which are likely to be lost or broken if their storage mode is not appropriate.

There are glasses holders which are intended to be fastened to a vehicle's sun visor and to hold the pair of glasses between the sun visor and the glasses holder.

In particular, U.S. Pat. No. 5,966,783 discloses a glasses holder made as a single piece of resiliently deformable material and comprising two tongues facing each other, an arc of circle-shaped connection part connecting an end of the first tongue to the corresponding end of the second tongue such that, when the glasses holder is fastened to a support, the inside surfaces of the tongues and of the connection part come to fit closely the edge of the support, the free ends of the tongues generally facing upwards.

On its lower surface, one of the tongues carries small protrusions which space out said tongue, referred to as a blocking tongue, from the support when the glasses holder is fastened thereto, in order to create a space in which the temples of a pair of glasses are accommodated.

An actuation tongue protrudes outwards from the outside surface of the connection part or of the blocking tongue. Since the actuation tongue is integral with the tongue which carries the protrusions, a pulling or pushing action onto the actuation tongue causes the blocking tongue to move away from the support, thereby enabling the temples of a pair of glasses to be positioned or removed within/from the space between the blocking tongue and the support.

A drawback of the glasses holder which is described above is that it is likely to detach from the support when the user pushes or pulls on the actuation tongue.

Further, providing for such a protruding actuation tongue is unaesthetic and makes the method for producing the glasses holder harder.

The present invention is intended to solve the aforementioned problems, by providing a glasses holder having a simple shape for an esthetic effect and a simple and inexpensive producing method, and which is not likely to detach from the support when the glasses are removed or positioned.

The applicant further realized that such a glasses holder is not limited to an application to pairs of glasses, but can be used to support any type of object.

Therefore, the present invention relates to an object holder which is intended to be removably fastened to the edge of a plate type support, which object holder comprises a tongue having a free end and carrying at its other end, with forming a connection area, a part which is turned back toward the tongue, the tongue and the turned-back part being resiliently deformable such that the object holder is able, in a rest position of the object holder, to clamp the edge of the support between the free end regions of the tongue and of the turned-back part, and, in a hooking position, to hold at least one object between the support and the tongue by means of hooking, characterized by the fact that the tongue carries, in the vicinity of the connection area, a protrusion which is directed toward the turned-back part and the free end of which is in contact with the support in the rest position of the object holder, the connection area being spaced apart from the support.

The free end of the protrusion thus constitutes a pivot point of the tongue when the user applies a pressure onto the outside surface of the connection area, the object holder being in a rest position, in order to enable the end region of the tongue to be spaced apart from the edge of the support through a lever effect, such spacing enabling the one or more objects to be positioned and removed between the support and the tongue.

In other words, the presence of the protrusion, the fact that the tongue and the turned-back part are resiliently deformable and the fact that the connection area between the tongue and the turned-back part is spaced apart from the support, when the object holder is fastened to the support and no object is hung thereto, enable in combination to place the object in the object holder or to remove it therefrom through a lever effect only by pressing the connection area of the object holder. Thus, the use of the object holder is particularly easy.

The features according to which the object holder is made of a resiliently deformable material and does not conform to the contour of the support to which it is fastened, enable to fasten the object holder to various supports.

Preferably, the protrusion consists in a tab the free border of which forms the free end of the protrusion in contact with the support in the rest position of the object holder.

Preferably, the tab is transversal to the middle longitudinal line of the tongue.

The tab advantageously extends over the entire width of the tongue, thereby maximizing the contact surface with the support in order to facilitate the lever effect.

The tab can be continuous or interrupted.

Preferably, the protrusion, where appropriate the tab, constitutes a protrusion for holding the one or more objects which are hooked to the object holder, the one or more objects being hooked by means of hanging by a part thereof which is located within the space formed between the protrusion, the tongue and the support when the object holder is fastened to the support.

Preferably, the tongue, the protrusion and the turned-back part are made as a single piece.

Consequently, the method for producing the object holder is simple and inexpensive.

Of course, the object holder can be made by joining several pieces to each other.

Any material which has, when it is deformed, an elasticity effect enabling the object holder to be clamped to the support can be used for the object holder. For example, plastic materials such as polycarbonate, shape-memory metal alloys, etc. can be mentioned.

The free end region of the tongue can be bent in a direction opposite to the protruding direction of the protrusion in order to define a rounded area.

Thus, when fastening the object holder to the support, the tongue does not damage the support because this is a rounded area which comes into contact with the support.

When the object holder is not fastened to the support, the free end of the turned-back part can be located in the vicinity of the tongue, mid-length thereof.

This enables to further limit the likelihood that the object holder detaches from the support to which it is fastened, by reinforcing the blocking of the object holder to the support, while facilitating the lever effect.

The connection area between the tongue and the turned-back part can have the shape of an arc of circle, which is bent toward the tongue.

This shape enables the user of the object holder to apply a pressure onto the arc of circle-shaped connection area effortlessly and conveniently.

The tongue can be tapered from the turned-back part to the free end of the tongue. This enables to optimize the quantity of material which is used, in order to decrease the production cost, while giving a visually esthetic aspect to the object holder.

Preferably, the protrusion forms a right angle with the tongue. Here again, such a configuration enables to reinforce the blocking of the object holder in the rest position of the latter while facilitating the lever effect for its opening.

Preferably, the object holder is made of injected plastic material.

Consequently, the object holder is light and inexpensive.

The object holder can constitute a glasses holder, the space which is formed, in the rest position of the object holder, by the support, the protrusion and the region of the tongue which is located between the protrusion and the free end region of the tongue, having a sufficient size to accommodate the temples which are folded against each other or the nose of a pair of glasses.

In order to better illustrate the subject matter of the present invention, a preferred embodiment thereof will be described hereinafter with reference to the appended drawings.

In these drawings:

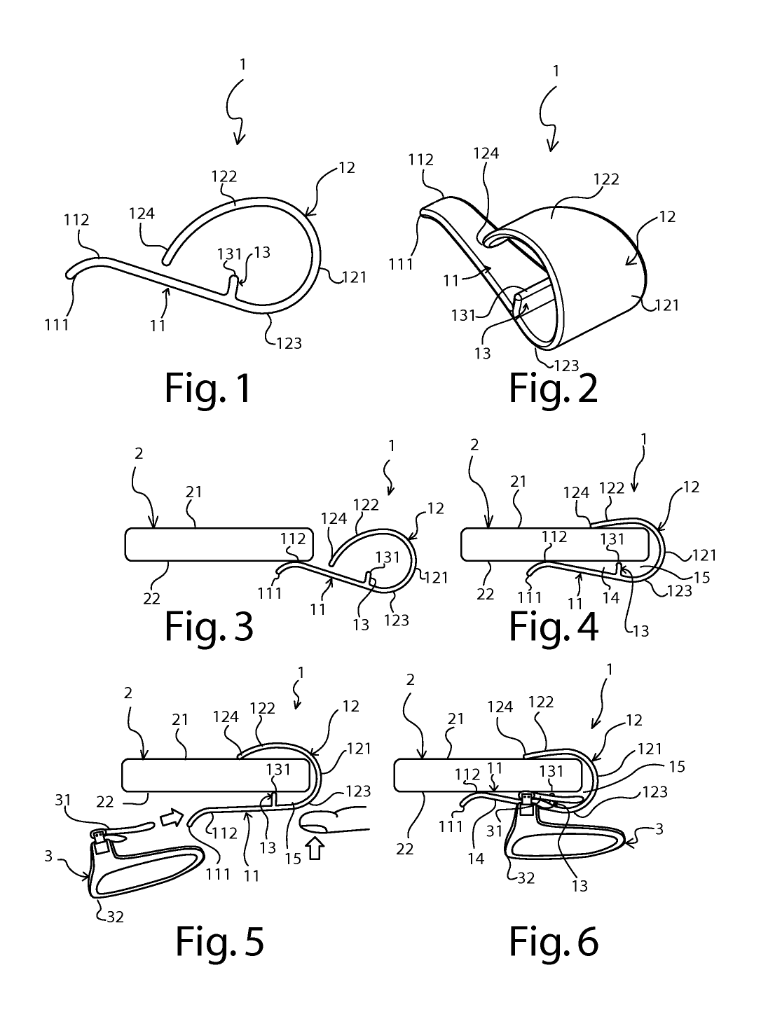

FIG. 1 is a side view of the object holder according to the present invention;

FIG. 2 is a perspective view of the object holder according to the present invention;

FIG. 3 is a side view showing the object holder according to the present invention at the very beginning of its positioning on the edge of a support;

FIG. 4 is a side view showing the object holder according to the present invention in a rest position, fastened to the edge of the support and without any object hooked thereto; and

FIGS. 5 and 6 are side views showing the object holder according to the present invention fastened to the edge of the support, respectively in an open position, with the aim to positioning a pair of glasses, and in a closed position for being hooked with the pair of glasses which is held between the object holder and the support.

With reference to FIGS. 1 and 2, it can be seen that a preferred embodiment of the object holder 1 according to the present invention is shown.

The object holder 1 is made up of an integral part which comprises a tongue 11, a turned-back part 12 and a tab 13 (or protrusion).

The tongue 11 is in the form of a long material strip which is tapered from a wide end to a free end 111 which is narrower and slightly bent in the direction opposite to the turned-back part 12, forming a rounded area 112. The part of the tongue 11 between the rounded area 112 and the wide end is straight.

The turned-back part 12 is in the form of a long material strip composed of first and second turned-back part sections 121 and 122 respectively.

The first turned-back part section 121, or first section 121, extends from the wide end of the tongue 11, by forming a connection area 123 which firstly is in the extension of the tongue 11 and then is bent toward the latter, the cross-section profile of the first section 121 following a semi-circle such that the end of the first section 121 is generally opposite the connection area 123.

Further, the first connection section 121 gets wider from the connection area 123 to mid-length of the first section 121, and is then tapered to its other end from which the second turned-back part section 122, or second section 122, extends.

The second section 122 is also in the form of a long material strip which firstly extends in the extension of the first section 121 and then is bent toward the tongue 11, its free end 124 being located in the vicinity of the tongue 11 and mid-length of the latter. The second section 122 is tapered from its connection end to the first section 121 to its free end 124.

The tab 13, having a free border 131, is carried by the tongue 11 in the vicinity of the connection area 123 and projects, perpendicularly to the tongue 11, toward the surface of the turned-back part 12 facing the tongue 11. The tab 13 is transversal to the middle longitudinal line of the tongue 11 and extends over the entire width of the latter.

The tongue 11, the first and second sections 121 and 122 and the tab 13 are made of a resiliently deformable material and the different material strips have the same thickness.

In the illustrated embodiment, the object holder 1 is made as a single piece, the different aforementioned material strips therefore consisting in a single material strip.

The use of the object holder 1 will now be described with reference to FIGS. 3 to 6.

With reference to FIG. 3 firstly, it can be seen that the object holder 1 is shown at the beginning of its positioning on a plate type support 2, only the edge of which is shown, which one has a first surface 21 and a second surface 22 which are parallel to each other.

In order to fasten the object holder 1 to the edge of the support 2, for example, the region of the free end 111 of the tongue 11 is positioned opposite the second surface 22 and the rounded area 112 is placed in contact with the second surface 22.

Then, the free end 124 of the turned-back part 12 is moved away from the first tongue 11 and the object holder 1 is moved forward on the support 2 in order to lead the latter into the space thus created between the tongue 11 and the first section 122 of the turned-back part 12.

Then, the first section 122 is released, which one thus comes to lean against the first surface 21 of the support 2.

The elasticity of the material used for the object holder 1 and the fact that it was deformed when the tongue 11 was moved away from the second section 122 of the turned-back part 12, tend to bring the tongue 11 and the second section 122 back to each other.

Consequently, in the rest position, the object holder 1 is reliably held on the support 2 by a clamping action between the free end 124 of the second section 122 in contact with the first surface 21 and the rounded area 112 of the tongue 11 in contact with the second surface 22 of the support 2, surface 22 with which the free border 131 of the tab 13 is in contact, as shown in FIG. 4.

It can also be seen on this Figure that the tongue 11 gradually moves away from the second surface 22 of the support 2, from the rounded area 112. In this way, the connection area 123 is spaced out from the support 2.

Further, due to its arc of circle shape, the first section 121 of the turned-back part 12 is also moved away from the edge of the support 2.

Finally, the space formed between the second surface 22 of the support 2 and the tongue 11 is divided by the tab 13 into a first space 14 which is intended to accommodate one or more objects for hooking them by means of hanging and a second space 15 enabling the opening of the object holder 1.

Indeed, with reference to FIG. 5, when one desires to hang one or more objects to the support 2, the object holder 1 being already in the rest position, one just has to press down, for example with a finger, at the connection area 123, from the outside of the object holder 1, in order to move the free end region of the tongue 11 away from the support 2 and to open the first object accommodation space 14, the free border 131 of the tab 13 serving as a pivot point so that the part of the tongue 11 extending from the tab 13 to the free end 111 can tip over in the direction opposite to the support 2.

Such an opening of the object holder 1 by the tongue 11 tipping over is allowed by the tongue 11 and the turned-back part 12 being able to deform, by the presence of the second space 15 between the connection area 123 and the support 2 and by the fact that the free border 131 of the tab 13 is leaning against the support 2.

Once the object holder 1 is in its open position, as shown in FIG. 5, one just has to place the object in the first object accommodation space 14, and then to release the pressure onto the connection area 123, the elasticity of the material used for the object holder 1 bringing the rounded area 112 of the tongue 11 back against the second surface 22 of the support 2 and closing the first space 14.

It should be underlined that an object, for example one or more sheets, could also be placed such that the object is held by being sandwiched between the rounded area 112 and the support 2 when the pressure onto the connection area 121 is released.

In the event of using the object holder 1 as a glasses holder, which has been shown in FIGS. 5 and 6, the temples 31 of the glasses 3 are folded against each other and blocked in the first space 14, between the rounded area 112, the tab 13 and the support 2. Thus, the glasses 3 are hung to the tongue 11, the temples 31 lying on the surface of the tongue 11 facing the element support 2.

In order to do this, when the object holder 1 is in an open position, the glasses 3 are threaded through the tongue 11, with the temples 31 folded against each other, by passing the tongue 11 between the temples 31 and the nose 32 of the glasses 3, as shown in FIG. 5, and then the pressure applied onto the connection area 121 is released.

The glasses 3 are therefore securely hung by their temples 31. Of course, the glasses 3 can be hung by their nose 32.

Further, the tab 13 enables to hold the temples 31 or the nose 32 of the glasses 3 in a more reduced space, thereby preventing the glasses 3 from moving when they are hung by the object holder 1.

When one wants to recover the glasses 3, one just has to apply a pressure again onto the connection area 123 in order to move the tongue 11 away from the support 2, to open the first space 14 and to access the glasses 3.

In some cases, the thickness of the temples 31 of the glasses 3 can be such that the free border 131 of the tab 13 is not in contact with the support 2 in the hooking position of the object holder 1. The glasses can then be removed simply by pulling on them in order to space apart the tongue 11 from the support 2, such that, when moving from the rest position to the open position of the object holder 1, the spacing of the tongue 11 by the glasses 3 produces a lever effect which, this time, tends to bring the connection area 123 back to the support 2, thereby reinforcing the blocking action on the support 2.

Consequently, the object holder 1 according to the present invention enables, in all cases, to place the glasses 3 in the object holder 1 and to remove them therefrom without the object holder 1 being likely to detach from the support 2 to which it is fastened.

Of course, the embodiment which was described above was given by way of example but not as a limitation and modifications can be made without departing from the scope of the present invention.

1-11. (canceled)

12- An object holder which is intended to be removably fastened to the edge of a plate type support, which object holder comprises a tongue having a free end and carrying at its other end, with forming a connection area, a part which is turned back toward the tongue, the tongue and the turned-back part being resiliently deformable such that the object holder is able, in a rest position of the object holder, to clamp the edge of the support between the free end regions of the tongue and of the turned-back part, and, in a hooking position, to hold at least one object between the support and the tongue by means of hooking, characterized by the fact that the tongue carries, in the vicinity of the connection area, a protrusion which is directed toward the turned-back part and the free end of which is in contact with the support in the rest position of the object holder, the connection area being spaced apart from the support.

13- The object holder according to claim 12, characterized by the fact that the protrusion consists in a tab the free border of which forms the free end of the protrusion in contact with the support in the rest position of the object holder.

14- The object holder according to claim 12, characterized by the fact that the protrusion constitutes a protrusion for holding the one or more objects which are hooked to the object holder, the one or more objects being hooked by means of hanging by a part thereof which is located within the space formed between the protrusion, the tongue and the support in the hooking position of the object holder.

15- The object holder according to claim 12, characterized by the fact that the tongue, the protrusion and the turned-back part are made as a single piece.

16- The object holder according to claim 12, characterized by the fact that the free end region of the tongue is bent in a direction opposite to the protruding direction of the protrusion in order to define a rounded area.

17- The object holder according to claim 12, characterized by the fact that, when it is not fastened to the support, the free end of the turned-back part is located in the vicinity of the tongue, mid-length thereof.

18- The object holder according to claim 12, characterized by the fact that the connection area between the tongue and the turned-back part has the shape of an arc of circle, which is bent toward the tongue.

19- The object holder according to claim 12, characterized by the fact that the tongue is tapered from the turned-back part to the free end of the tongue.

20- The object holder according to claim 12, characterized by the fact that the protrusion forms a right angle with the tongue.

21- The object holder according to claim 12, characterized by the fact that it is made of injected plastic material.

22- The object holder according to claim 12, constituting a glasses holder, characterized by the fact that the space which is formed, in the rest position of the object holder, by the support, the protrusion and the region of the tongue which is located between the protrusion and the free end region of the tongue, has a sufficient size to accommodate the temples which are folded against each other or the nose of a pair of glasses.
